(19) United States
(12) Patent Application Publication
(10) Pub. No.: US 2011/0132377 A1
(43) Pub. Date: Jun. 9, 2011

(54) THERAPEUTIC DEVICE FOR INDUCING BLOOD PRESSURE MODULATION

(76) Inventor: Edward H. Phillips, Troy, MI (US)

(21) Appl. No.: 13/057,778

(22) PCT Filed: Aug. 7, 2008
(86) PCT No.: PCT/US2008/072456

§ 371 Date: Feb. 7, 2011

(51) Int. Cl. A61G 7/043

(52) U.S. Cl. 128/845

(57) ABSTRACT

A Kinetic Recliner Bed or Chair apparatus intended for enhancing blood circulation, and lymph and neural fluid flow throughout a person's body. The person is placed supinely in a comfortable and relaxed state on a bed or chair member that is driven, either at the nominal cyclic rate of a human lymph system's normal lymphangion contraction rate divided by 2, or alternately, at the nominal cyclic rate of a human lymph system's normal lymphangion contraction rate, in a cyclic tilting seesaw mode that alternatively raises the person's upper torso and head above his or her lower extremities, and vice-versa.

### RELATED PATENTS AND APPLICATIONS

The present application is a U.S. National Phase of PCT Application PCT/US2008/072456 filed on Aug. 7, 2008, which is related to U.S. Pat. No. 7,276,033 (hereinafter “the '033 patent”) issued on Oct. 2, 2007 and entitled “Rhythmic Blood Pressure Modulation and Legshaking Apparatus”; and is a continuation-in-part of U.S. patent application Ser. No. 12/134,544 (hereinafter “the '544 patent application”) filed on Jun. 6, 2008 and entitled “Therapeutic Device for Inducing Blood Pressure Modulation”; which was a continuation-in-part of U.S. patent application Ser. No. 12/108,901 (hereinafter “the '901 patent application”) filed on Apr. 24, 2008 and also entitled “Therapeutic Device for Inducing Blood Pressure Modulation”; which was a continuation-in-part of U.S. patent application Ser. No. 12/106,534 (hereinafter “the '534 patent application”) filed on Apr. 21, 2008 and also entitled “Therapeutic Device for Inducing Blood Pressure Modulation”; which was a continuation-in-part of U.S. patent application Ser. No. 11/961,305 (hereinafter “the '305 patent application”) filed on Dec. 20, 2007 and also entitled “Therapeutic Device for Inducing Blood Pressure Modulation”; which was a continuation-in-part of U.S. patent application Ser. No. 11/775,507 (hereinafter “the '507 patent application”) filed on Jul. 10, 2007 and also entitled “Therapeutic Device for Inducing Blood Pressure Modulation”; which in turn was a continuation-in-part of U.S. patent application Ser. No. 11/749,505 filed on May 16, 2007 and also entitled “Therapeutic Device for Inducing Blood Pressure Modulation” now abandoned. The '033 patent and the '544, '901, '534, '305 and '507 patent applications are expressly incorporated herein by reference.

### BACKGROUND OF THE INVENTION

The present invention relates generally to therapeutic devices and, more particularly, to a therapeutic device and a method of use therefor that is believed herein to enhance blood circulation as well as lymph and neural fluid flows throughout a person's body.

Various types of devices have been used for enhancing blood flow through selected portions of human cardiovascular systems. This has been done for the purpose of alleviating various symptoms associated with different types of diseases or conditions. For example, enhanced external counter-pulsation (hereinafter “EECP”) utilizes pressure cuffs around various portions of a person's lower extremities and buttocks. The pressure cuffs are sequentially and abruptly inflated and then deflated in sync with the person's heart rate such as to implement a reverse pulsation of blood flow back toward the person's upper torso and head immediately following systole. This results in pressure spikes of as much as 50 mmHg being imposed upon any partial arterial blockages that may be present in those portions of the person's body, and may in fact enable formation of collateral circulation passages around such partial blockages. In order to be effective, EECP is typically administered to a person over a series of 35 one-hour treatments during a seven-week period. During their abrupt inflation the pressure cuffs can often inflict significant discomfort in the person however, thereby causing him or her to be distressed and perhaps counteracting the therapeutic effect for which the device was intended. Furthermore, there has apparently been no suggestion that EECP is helpful in promoting enhancement of either lymph or neural fluid flows within the human body.

Another device was described in a book entitled “Surgical Nursing” by Eliason, Ferguson and Farrand and published as early as 1929 by the J.B. Lippincott Company. It was called a “Sander's oscillating bed for treatment of peripheral vascular disease”. In describing the Sander's oscillating bed and its use the authors stated the following:

“The Sander's oscillating bed is a method of administering passive exercises to allow intermittent filling and emptying of capillaries, venules and arterioles. The bed is set upon a rocker operated by a motor so that it tilts on its long axis at regular intervals. The intervals may be adjusted according to the needs of the patient and the wishes of the physician. This method of administering passive postural exercises may be carried out day and night and is claimed by some to have produced relief of the rest pain and of the pain associated with ulcers and gangrene. It may be used not only in arteriosclerosis and thrombo-angitis obliterans but also in minor degrees of arterial embolism.”

The Sander's oscillating bed was also described in the Aug. 4, 1951 issue of the Journal of the American Medical Association as being utilized at “high frequency” as a “vasoscillator”—thus implying that it was useful for dilating clogged blood vessels. It is believed herein that when it was utilized for this purpose, the Sander's oscillating bed was driven at a relatively high frequency significantly beyond 20 cycles/minute. On the other hand, other articles published during the 1950s detailed its use for augmenting ventilation in patients with poliomyelitis. This was obtained via internal manipulation of the patient's lungs obtained as a result of alternating gravitational forces cyclically displacing the patient's intestines such as to cyclically elevate and depress his or her diaphragm. In this case, the Sander's oscillating bed was driven at a “relatively low frequency” of perhaps 20 cycles/minute that was considered to be compatible with a normal rate of breathing.

As will be fully explained below, it is believed herein that operation of such a bed at the high frequencies noted above would be grossly inappropriate. First of all, it would most likely induce discomfort in the patient. More significantly, there would be insufficient time to substantially drain pooled venous blood from selected portions of a person's venous system during the portion of each cycle when they are subject to pressure values lower than atmospheric pressure, or later during the cycle, to totally fill the veins comprised in those portions of the person's venous system with new venous blood coming from associated arterioles, capillaries and venules—when otherwise those veins would have dilated and become subject to pressure values greater than atmospheric pressure. Thus, implementation of even the basic concept of venous blood pressure modulation as explained below would not be possible on a Sander's oscillating bed operated at the high frequencies noted above. But as is also explained below and perhaps in some cases of even more significance, such high frequency operation would be totally incompatible with enhancing operation of a person's lymph system.

Further, it is also believed herein that all versions of the Sander's oscillating bed were implemented with a flat (e.g., planar) bed and, as implied above, “set upon a rocker operated by a motor so that it tilts on its long axis at regular intervals”. Because of such construction, it is also believed herein that shoulder and/or foot constraints were typically utilized for longitudinally restraining patients so that they wouldn't slide “up or down” excessively. It is believed herein that use of such artificial shoulder and foot constraints would also tend to induce discomfort in the patient. Perhaps because of the requirement for such artificial constraints, or because of the above explained high frequency misapplication in its use, or even simple patient discomfort associated with the high frequency operation, or because of safety concerns relating to the open rocker construction, the Sander's oscillating bed obviously fell out of favor.

An alternate type of therapeutic device that includes a bench or support member upon which a person can lie down is described in detail in U.S. Pat. No. 6,261,250. Harnesses are attached to each arm and leg of the person. The harnesses are attached to cables actuated by a gearmotor in a manner that cyclically and synchronously raises and lowers all of the person's limbs. The change in elevation of the person's limbs causes a moderate modulation of blood pressure in both of the arterial and venous networks of the person's cardiovascular system. Although it runs at a cyclic rate of slightly over 20 times/minute, this therapeutic device is none-the-less believed to be somewhat effective in enhancing blood flow throughout the person's circulatory system, including his or her coronary system as well as in his or her brain. In addition, it is also believed to be somewhat effective in enhancing neural fluid flow within the person's body generally, and particularly in the brain. However, it does require an amount of coordinated muscle activity on the person's part to properly position him- or her-self on the bench and maintain his or her limbs within the harnesses, as well as to properly interact with the device. For some people, such interactions can be stressful and could even somewhat counteract the therapeutic effect for which the device is intended. Furthermore, the therapeutic device depicted in the '250 patent comprises an open counter-balanced flywheel that for safety reasons would obviously be of concern.

Patent application Ser. Nos. '544, '901, '534, '305 and '507 provide detail descriptions of an improved therapeutic method and first and second self-operated therapeutic devices for inducing blood pressure modulation therapy (hereinafter “BPM therapy”). The first and second self-operated therapeutic devices are respectively referred to as a Kinetic Recliner Bed and a Kinetic Recliner Chair (hereinafter “recliner bed and chair”). Utilization of either of the recliner bed or chair in accordance with the preferred methods described in patent application Ser. Nos. '544, '901, '534, '305 and '507 has been shown to provide numerous therapeutic benefits resulting from enhanced blood, lymph and neural fluid flows in a person's body and brain. The person places him or herself in a generally supine position on a support member of the recliner bed or chair (hereinafter “bed or chair member”) formed in a contoured manner whereupon he or she can comfortably lie without artificial constraints. A drive mechanism is used to cyclically move the bed or chair member in a seesaw manner in order to elevate the person's upper torso and head above his or her lower extremities, and then to elevate the person's lower extremities above his or her upper torso and head. As stated in the patent application Ser. Nos. '544, '901, '534, '305 and '507, the preferred cyclical rate of motion of the bed or chair member was about 6 cycles/minute and its preferred total angular range of motion relative to its nominally centered horizontal position was around 30°.

Operationally, the recliner bed or chair and their preferred BPM therapy method of utilization as stated in patent application Ser. Nos. '544, '901, '534, '305 and '507 have been satisfactory in every way when operated in accordance with the therein stated preferred cyclical rate of motion of the bed or chair member of about 6 cycles/minute. The recliner bed and chair are robust and quite reliable in operation, and are thus suitable for continuous use in clinical applications as well as in a person's home. Surprisingly however and with considerable experimentation, it has just now been found that operation of either of the recliner bed or chair at a frequency of about 3 cycles/minute may actually be preferable for some uses.

Therefore, it would be highly advantageous to provide method and apparatus for selectively enabling operation of the recliner bed and chair at frequencies of either 3 or 6 cycles/minute in order to in turn enable an optimized method of BPM therapy for each person's health issue as deemed most appropriate for that person.

### SUMMARY OF THE INVENTION

Thus the present invention relates to an improved apparatus and therapeutic method for enabling and utilizing BPM therapy, wherein the improved apparatus enables operation of the recliner bed and chair at frequencies of either 3 or 6 cycles/minute and the improved therapeutic method comprises a selection of either of the 3 or 6 cycles/minute operational frequency as deemed most appropriate for each person's health issue. As described in patent application Ser. Nos. '901, '534, '305 and '507, operation at a frequency of about 6 cycles/minute was thought to be optimum because that was a frequency that fell within the natural frequency of operation of the lymph system (i.e., a frequency falling within the natural lymphangion spiral muscle contraction rate of 5 to 8 cycles/minute). While it has been found that a person's actual frequency of operation of his or her lymph system can indeed synchronously “lock on” to the 6 cycles/minute rate, it has also surprisingly been found that one's lymph system can also and sometimes even more beneficially “lock on” to the above mentioned 3 cycles/minute rate in a synchronous manner with every other lymph system cycle being in phase with the motion of the recliner bed or chair. In so doing lymph seems to gather during an “off” cycle when the lymph flow direction is “uphill” and then flow even more dramatically during an “on” cycle when the lymph flow direction is “downhill”.

Further, because two cycles of lymph operation occur during each cycle of recliner bed or chair operation, all portions of the person's lymph system can concomitantly fire and still be “locked on” in phase with the recliner bed or chair motion. Thus, those portions of the person's lymph system comprised in the upper torso and head, and those comprised in the lower extremities can both be disposed in a favorable “downhill” orientation as they fire during alternate cycles. In addition, resulting doubled dwell times give more time for realization of an improved modulation of blood flow and pressure. Thus it is believed herein that in some cases these benefits might outweigh the obvious benefit of achieving twice as many modulation cycles of blood flow and pressure during the same time period at the 6 cycles/minute frequency while the reverse might be true in other cases.

The improved apparatus for enabling operation of the recliner bed and chair at frequencies of either 3 or 6 cycles/minute comprises a gearmotor with either a two-speed drive motor, or a purpose-designed and built controller and a three-phase drive motor for driving a speed-reducing gearbox thereof. If the purpose designed and built controller and three-phase drive motor are selected for this purpose, then the purpose-designed and built controller would include a three-phase inverter operating in a pulse width modulated mode controlled in accordance with a selected volt/Hz value. In addition, it is imperative that such a purpose-designed and built controller operate in a substantially electro magnetic interference (hereinafter “EMI”) free manner because of its proximity to persons using the recliner bed or chair. Thus, low pass filtering would be provided for both of its input and output power lines.

It should be emphasized that utilization of the recliner bed or chair does not impose a medically oriented treatment upon a person similarly to that such as he or she would typically experience via utilizing invasive types of treatment provided by a medically licensed physician through his or her prescription of medication, or by executing a surgical procedure. Rather, its use is generally non-invasive in nature and can be used by any person at his or her own volition. Alternately of course, it can be utilized with the assistance of an alternative medicine practitioner, or even at the suggestion of a medically licensed physician. In fact, its use by any person can more accurately be described as that of non-invasively conditioning that person so that his or her body can be enabled for improving, or even possibly for curing, itself.

Other benefits, features and aspects of the present invention will become apparent from a review of the following description of preferred embodiments, when viewed in accordance with the attached drawings and appended claims.

### BRIEF DESCRIPTION OF THE DRAWINGS

FIGS. 1A, 1B and 1C are side views illustrating the configuration and range of motion of a Kinetic Recliner bed.

FIGS. 2A, 2B and 2C are side views similarly illustrating the configuration and range of motion of a Kinetic Recliner chair.

FIG. 3 is a schematic view of the cardiovascular circulatory system.

FIG. 4 is a schematic view of a greatly enlarged minute portion of a capillary bed.

FIG. 5 is a schematic view of a lymph collector.

FIGS. 6A and 6B are schematic views of a lymph pre-collector.

FIG. 7 is a sectional view of a human eye.

FIG. 8 is a perspective view of an example drive mechanism for cyclically moving either of the kinetic recliner bed depicted in FIGS. 1A, 1B and 1C or the kinetic recliner chair depicted in FIGS. 2A, 2B and 2C at either of the preferred 3 cycles/minute or 6 cycles/minute operational frequencies.

FIG. 9 is a schematic drawing of a controller utilized for driving the example drive mechanism depicted in FIG. 8.

FIG. 10 is a flow chart that illustrates an optimized method of providing BPM therapy for therapeutically treating each person's health issue as deemed most appropriate for that person on either of the kinetic recliner bed depicted in FIGS. 1A, 1B and 1C or the kinetic recliner chair depicted in FIGS. 2A, 2B and 2C.

### DETAILED DESCRIPTION OF THE PREFERRED EMBODIMENTS

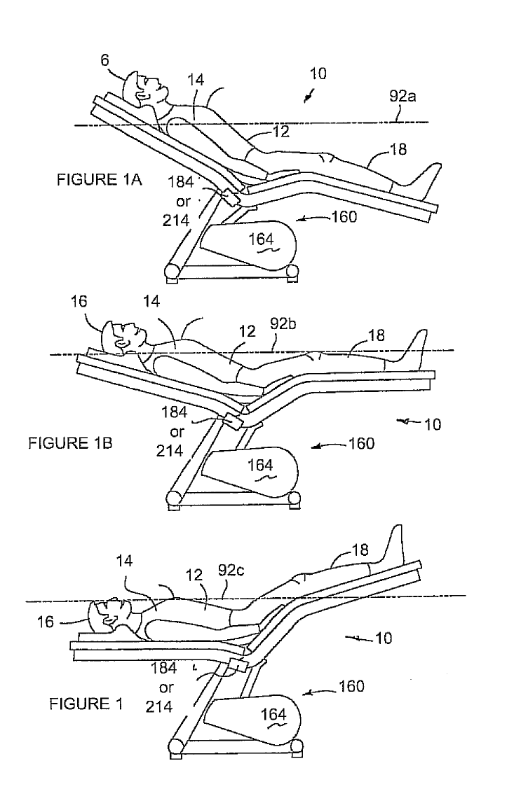

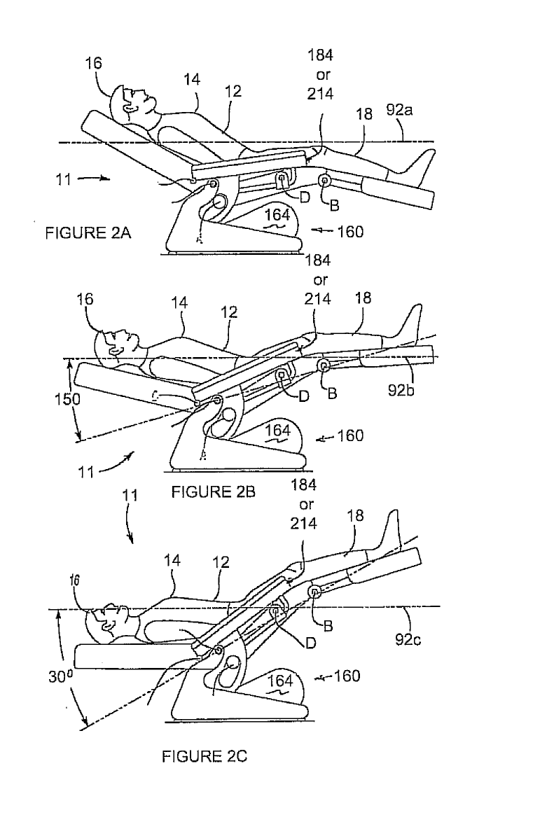

FIGS. 1A, 1B and 1C, and 2A, 2B and 2C are side views respectively illustrating the range of motion of an example Kinetic Recliner Bed 10 (hereinafter “recliner bed 10”) and an example Kinetic Recliner Chair 11 (hereinafter “recliner chair 11) disposed in a fully reclined position, wherein FIGS. 1A and 2A depict an initial portion of their cycles of operation whereat a person 12's upper torso 14 and head 16 (hereinafter “upper torso and head 14/16”) are elevated; FIGS. 1B and 2B depict the portions of the cycle whereat the person 12 is disposed in a nominally horizontal position; and FIGS. 1C and 2C depict the portion of the cycle whereat the person 12's lower extremities 18 are elevated. As set forth elsewhere herein, first and second preferred rates of cyclical motion for the recliner bed 10 and recliner chair 11 are about 3 and 6 cycles/minute respectively, and the total angular range of motion for each is around 30°. For convenience the recliner bed 10 and recliner chair 11 will hereinafter be referred to as the recliner bed and chair 10/11.

When used in accordance with an example preferred method of providing optimized BPM therapy for therapeutically treating each person's health issue as deemed most appropriate for that person at either of the preferred cyclical rates of 3 or 6 cycles/minute (i.e., hereinafter “BPM therapy method 100” as described below and depicted in FIG. 10), they are hypothesized to provide enhanced blood, lymph and neural fluid flows in the human body and brain. In some anecdotal examples, utilization of a recliner bed or chair 10/11 has been helpful for enabling an improved quality of life for persons having various types of physical and neural diseases or conditions such as peripheral artery disease, Parkinson's disease, Alzheimer's disease, essential tremor, muscular dystrophy, autism, migraine headaches, traumatic brain injuries, varicose veins, fibromyalgia, eye problems such as wet macular edema, wet macular degeneration and glaucoma, and diabetes related problems such as high glucose count, impaired circulation, neuropathy, open wounds, and lymphedema with abnormal tissue swelling. In order to develop an understanding of the why utilization of a recliner bed or chair 10/11 is believed herein to be so operative, it is useful to first develop an in depth understanding of the functioning of the human circulatory and lymph systems.

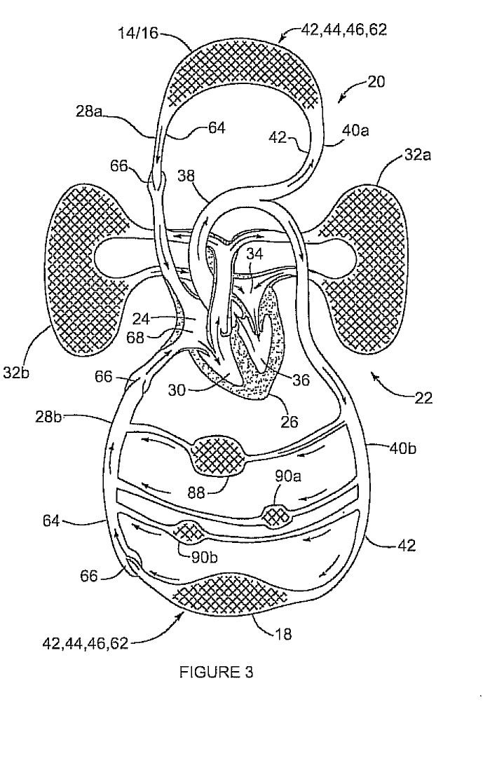

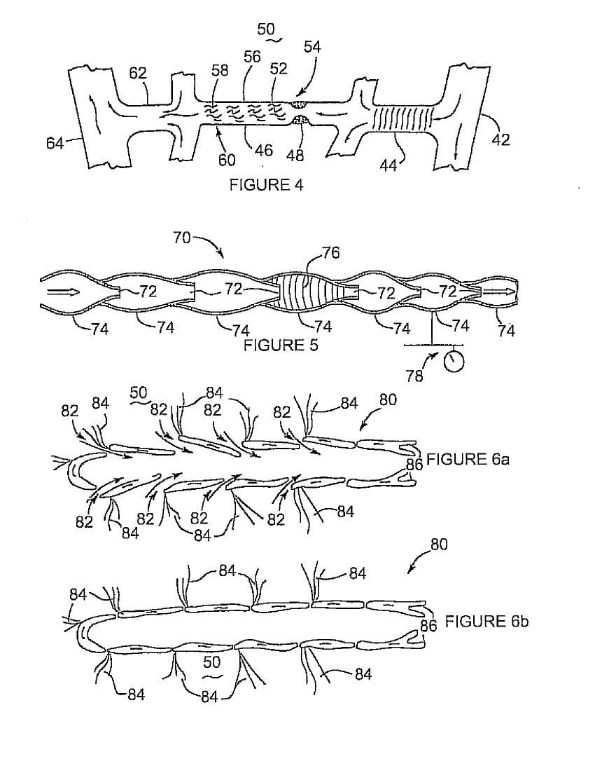

FIG. 3 depicts a human circulatory system 20 in a highly simplified schematic manner. The cardio-pulmonary portion 22 of the human circulatory system 20 includes the right atrium 24 of the heart 26 receiving oxygen-depleted blood from upper and lower body venous networks 28a and 28b (hereinafter “venous system 28a/28b”), pumping it via the right ventricle 30 through left and right lungs 32a and 32b wherein carbon dioxide is exchanged for oxygen, then on to the left atrium 34 and ventricle 36 of the heart 26 from where the now oxygen-rich blood is pumped into the aorta 38, and from there to the upper and lower body arterial networks 40a and 40b (hereinafter “arterial system 40a/40b”). The arterial system 40a/40b comprises an enormous multitude of ever-finer arteries 42 and arterioles 44 that convey the oxygen-rich blood from the heart 26 to a truly extraordinary multitude of perhaps a billion or more capillaries 46 (i.e., with one set thereof being shown in a highly simplified schematic manner in FIG. 4).

Layers of smooth spirally oriented muscle cells (not shown) are comprised in the arteries 42. They serve to maintain finite values of arterial blood pressure between systolic events. Similar but much finer layers of smooth spirally oriented muscle cells (also not shown) are also comprised in the arterioles 44. These finer layers of smooth spirally oriented muscle cells are utilized by a cardiovascular control center (not shown) in the brain for selectively controlling arteriole size and thus blood flow resistance. Further as illustrated in the highly magnified schematic view of FIG. 4, a pre-capillary sphincter 48 protects each capillary 46. The pre-capillary sphincters 48 are utilized by the cardiovascular control center for selectively maintaining instant proportions of the capillaries 46 that are open to blood flow at any particular time in any portion of the body. These factors permit the brain to execute an almost incomprehensibly complex task of regulating blood flow throughout the human circulatory system 20 as well as controlling instant blood pressure values and selectively servicing trauma of any type (i.e., including minor trauma such as a cut or scrape).

Additionally, the brain indirectly controls heart rate via generating neural inputs to sympathetic and parasympathetic nerve fibers (not shown) in the heart 26. Although the complexity of this control system is truly amazing, it has a rather slow response time. One indication of this slowness is the length of time (i.e., in the order of a minute or more) for a minor scrape to be serviced by the arrival of fresh blood that occurs via the opening of a multitude of juxtaposed pre-capillary sphincters 48. As described below, this slowness in response time relative to the preferred nominal cyclical rate of motion of either 3 or 6 cycles/minute is important with respect to utilization of the BPM therapy method 100.

As will be discussed in greater detail below and in accord with the Starling equation (i.e., and equation named after British physiologist Ernest Starling that refers to fluid movement across a capillary membrane), blood flows through the open ones of the capillaries 46 wherefrom oxygen, sugar, insulin, fat and protein bearing plasma flows into surrounding interstitial space 50 through micro-pores 52 located near the moderately pressurized arteriole/sphincter ends 54 of the capillary walls 56. Carbon dioxide and waste bearing plasma then flows back into the capillaries 46 via osmosis generated pressure through other micro-pores 58 located near the downstream or venule ends 60 of the capillary walls 56. Finally, the then oxygen depleted blood flows through venules 62 and into the venous system 28a/28b, which venous system 28a/28b acts as a reservoir containing about 65% of the body's total blood volume.

As shown schematically in FIG. 3, the larger veins 64 of the venous system 28a/28b comprise sequentially spaced semi-lunar folds that function as one-way check valves 66. The check valves 66 serve to preclude reverse flow back toward the venules 62 and capillaries 46. Generally the veins 64 and venules 62 of the venous system 28a/28b are simpler and more compliant than the arteries 42 and arterioles 44 of the arterial system 40a/40b. However, they also include layers of smooth spirally oriented muscle cells that (e.g., at least in the larger ones of the veins 64) are utilized by the cardiovascular control center for regulating their circumferential size. This involves the brain and body continuously executing a very complex and precise servo control of the volumetric size of the venous system 28a/28b as a whole, which servo control function also has a fairly long implementation time constant (e.g., longer than a single cycle of operation of a recliner bed or chair 10/11). The volumetric size of the venous system 28a/28b is controlled such that average venous blood pressure at the entrance to the heart 26 is maintained at a level just slightly above atmospheric pressure in response to signals emanating from a cardiopulmonary mechanoreceptor 68 located in the right atrium 24 of the heart 26. This results in average venous blood pressure being maintained at a zero value relative to atmospheric pressure at a horizontal plane 92 (e.g., shown in FIGS. 1A, 1B, 1C, 2A, 2B and 2C as zero venous pressure planes 92a, 92b and 92c) located a few inches thereabove (hereinafter generically referred to as the “zero venous pressure plane 92”).

As a result, venous blood pressure present at any particular point within a person's venous system can be determined by the formula

P_{V}=1.875h (1)

where P_{V} is the difference between venous blood pressure at that particular point and atmospheric pressure (in mmHg), and h is the vertical distance between that particular point and the vertical position of the zero venous pressure plane 92 (in inches). Thus, portions of the venous system 28a/28b that are instantly positioned vertically below the zero venous pressure plane 92 have positive pressure (e.g., relative to atmospheric or zero pressure) whereby there is a positive differential pressure value imposed between them and the outside of a person's body (not shown). On the other hand, portions of the venous system 28a/28b that are instantly positioned vertically above the zero venous pressure plane 92 have negative pressure whereby there is a positive differential pressure value imposed between the outside of the person's body and those portions of the venous system 28a/28b. This compresses those veins 64 and causes previously “pooled” venous blood contained therein to “drain” back toward the heart 26 (e.g., with the venous blood freely moving through the above described check valves 66) with the result that those veins 64 are compressed or even somewhat flattened out.

Then later in the cyclic motion of a recliner bed or chair 10/11 when those portions of the venous system are again positioned below the zero venous pressure plane 92, they fill with oxygen depleted blood flowing from juxtaposed capillaries 46 and venules 62 (e.g., not back down through the larger veins 64 themselves because of the one-way flow nature of the check valves 66) and expand. In either of these cases, it is believed herein that it is necessary to provide adequate time for allowing these “draining and filling” functions to substantially occur. Thus while the preferred nominal cyclic rates of operation of 3 and 6 cycles/minute are believed to be sufficiently quicker than the above described slowness in cardiovascular system response time to retain a substantially constant venous system volume, they (especially the 3 cycles/minute frequency) are also believed to be slow enough to substantially allow the also described “draining and filling” functions to occur.

The above described general principle can be demonstrated by observing what happens to a visible peripheral vein running along the back of one's hand and arm as that hand and arm are slowly raised toward shoulder height. Portions of that vein will soften and contract, and even begin to flatten out as they reach shoulder height and then remain flattened while they are above that height. Then if one rapidly lowers the hand and arm he or she will observe a tendency for the veins 64 to fill “from the bottom”. It is believed herein that substantially the same actions occur within the fine venous system structures comprised in the upper torso and head 14116, and also within the lower extremities 18 of a person 12 whenever he or she is supinely disposed upon a cyclically moving recliner bed and chair 10/11.

Concomitantly, the arterial blood pressure present at any particular point within a person's venous system can be determined by the formula

Pₐ=Pₒ+1.875h (2)

where Pₐ is the difference between arterial blood pressure at that particular point and atmospheric pressure (in mmHg), Pₒ is instantaneous arterial blood pressure at his or her zero venous pressure plane 92 (in mmHg), and h is the vertical distance between that particular point and the vertical position of his or her zero venous pressure plane 92 (in inches). Thus, portions of the arterial system 40a/40b that are instantly positioned vertically below the zero venous pressure plane 92 have increased positive pressure. On the other hand, portions of the arterial system 40a/40b that are instantly positioned vertically above the zero venous pressure plane 92 have reduced positive pressure.

Such variations of the arterial and venous blood pressures are illustrated in FIGS. 1A, 1B, 1C, 2A, 2B and 2C for a person 12 disposed on a recliner bed or chair 10/11. Again, FIGS. 1A and 2A depict the initial portion of its cycle of operation whereat the person 12's upper torso and head 14/16 are elevated; FIGS. 1B and 2B depict the portions of the cycle whereat the person 12 is disposed in a nominally horizontal position; and FIGS. 1C and 2C depict the portion of the cycle whereat the person 12's lower extremities 18 are elevated. Of these, the nominally horizontal position depicted in FIGS. 1B and 2B can logically be said to approximate the average disposition of the person 12 when he or she is disposed upon the cyclically moving recliner bed and chair 10/11.

Thus, an average location of the zero venous pressure plane 92 can be approximated by a zero venous pressure plane 92b passing through the upper torso 14 of the nominally horizontally disposed person 12 depicted in FIGS. 1B and 2B whereby portions of the venous system above and below the zero venous pressure plane 92b are respectively subject to negative and positive pressure values. Zero venous pressure planes 92a and 92c respectively depicted in FIGS. 1A and 2A, and 1C and 2C similarly define instantaneous locations of the zero venous pressure plane at the extremes of cyclical motion of a recliner bed or chair 10/11. Thus the person 12's upper torso and head 14/16 are subject to alternating negative and then positive pressure values, even as his or her lower extremities 18 are concomitantly subject to alternating positive and then negative pressure values. Again, this occurs as a result of the above noted inability of the venous volumetric control system to quickly respond within the nominal preferred 3 and 6 cycle/minute operational frequencies of a recliner bed or chair 10/11.

Gravitational forces resulting from alternating cyclical elevation of the person 12's upper torso and head 14/16, and then lower extremities 18 rhythmically modulate both the instantaneous arterial and venous blood pressures in the upper torso and head 14/16, and the lower extremities 18, over a range of perhaps 20-30 mmHg in accord with equations (1) and (2) above. Thus when the upper torso and head 14/16, and alternately the lower extremities 18, attain peak elevation above zero venous pressure planes 92a or 92c as respectively depicted in FIGS. 1A and 1C, arterial blood pressure in those portions of the person 12's body is lowered by up to 15 mmHg while venous blood pressure in those portions of the person 12's body is lowered below atmospheric pressure to perhaps a negative value of as much as −15 mmHg. As a result, there is then a pressure differential of as much as 15 mmHg between atmospheric pressure externally impressed upon the person 12's body and the venous blood pressure within those portions of the his or her body. As explained above, this pressure imbalance forces the surrounding tissue to somewhat compress or shrink those portions of the venous system 28a/28b. This then forces venous blood to flow from those veins 64 generally toward the heart 26 (again, this phenomenon is responsible for the observed flattening of peripheral veins 64 in a person's hand and forearm as he or she raises that arm).

On the other hand, as the upper torso and head 14/16, or alternately, the lower extremities 18 are lowered as respectively depicted in FIGS. 1C and 2C, and 1A and 2A, arterial pressure values in those portions of the person 12's body rise in the head 16 by perhaps up to 10 mmHg and alternately in the lower extremities 18 by perhaps up to 20 mmHg above the instantaneous values present at the zero venous pressure planes 92c or 92a. Corresponding increases in venous blood pressure values lag behind because those veins 64 must first “fill up” with new venous blood issuing from their associated artery and arteriole fed capillaries 46 and venules 62. This of course is less of a factor when the recliner bed and chair 10/11 are operated at the nominal 3-cycle/minute rate. In any case, the alternate compression and then filling of these portions of the venous system 28a/28b implements a series of switching events wherein the body's tissue alternately shrinks and then swells. Otherwise of course, arterial and venous blood pressures in the remaining portions of the person 12's body are subject to continuous modulation at lesser values at either cyclical frequency.

As described in a book entitled “Exercise Physiology” by William D. McArdle, Frank I. Katch and Victor L. Katch and published by Williams & Wilkins of Baltimore, Md. and Media, Pa. (and again with reference to FIG. 4 herein) arterial pressure decreases by about 20% of the average value it had in the aorta by the time the arterial blood reaches the arterioles 44 and further decreases by perhaps another 35% as it passes through the arterioles 44. Further, the cyclic variation between systolic and diastolic pressures that is generally present in the arterial system 40a/40b pretty well dies out by the time the blood passes through the arterioles 44. Thus ignoring the gravity effects described elsewhere herein, blood pressure entering the arteriole/sphincter ends 54 of the capillaries 46 has a value of about 45% of the average arterial pressure present in juxtaposed portions of the arterial system 40a/40b. Then also ignoring the above described transient effect relating to the delayed filling of the veins 64, the pressure decreases by about another 25% as is passes through the capillaries 46. The transient effects could amount to as much as another 10% pressure drop or perhaps as much as a transient 40% increase in driving pressure through the capillaries 46 and the serial combination of the micro-pores 52, interstitial space 50 and micro-pores 58. Further, according to an analysis presented by Wikipedia the Starling equation predicts that a net outward driving pressure of about 12 mmHg from the arteriole/sphincter ends 54 of the capillaries 46 and a net inward driving pressure of about 5 mmHg into the venule ends 60 of the capillaries 46 results from a combination of capillary vs. interstitial hydrostatic and oncotic (osmotic) pressures. Thus in general, larger molecules (e.g., excess proteins) are not able to re-enter the venule ends 60 of the capillaries 46 because of the significantly lower inward driving pressure present there. As a consequence of this, there is a net outflow of fluid from the capillaries 46. As explained below with reference to FIGS. 5, 6A and 6B, the normal function of the lymphatic system is to drain this excess fluid from the interstitial space 50 and return it to an upper portion of venous system 40a near its entrance to the heart.

In general and especially in view of the compliant nature of surrounding tissue, all of these factors result in a rather complex modulation of interstitial fluid volume and pressure as a function of the cyclic motion of a recliner bed or chair 10/11. Generally the interstitial space 50 will vary between having a slightly swollen, pressurized condition when a portion of a person's anatomy is lowered and a somewhat shrunken non-pressurized condition when it is elevated. The point of all of this is that interstitial space volume and pressure will vary cyclically in a rather erratic yet synchronized (e.g., with the motion of a recliner bed or chair 10/11) manner at nominal frequencies of either 3 or 6 cycles/minute. Further, it is also apparent that the pressure drop across the various comprised flow channels and orifices varies in a similarly erratic yet synchronized manner as well. It is believed that these actions result in a general massaging of the tissue and a tendency to break up any blockages generally present in the various flow channels and orifices, and specifically those that might be present in lymph flow channels.

Again, pressure present within the arteriole/sphincter ends 54 of the capillaries 46 is sufficient to drive plasma comprising oxygen, sugars, protein, fat and doubtless other material into the surrounding interstitial space 50 through the first encountered micro-pores 52 and thus become interstitial fluid that enables oxygen and nutrients to be delivered to the tissue. Then generally, the interstitial fluid “morphs” via the oxygen/carbon dioxide exchange as well as through most of the other materials being replaced by waste products. As noted above, the net inward driving pressure of about 5 mmHg into the venule ends 60 of the capillaries 46 is normally able to drive most of the interstitial fluid back into those capillaries 46 via the micro-pores 58. Again however, the remaining excess interstitial fluid (i.e., comprising some of the excess protein, fat and other waste material) is normally removed by a person's lymph system.

As described in detail in a book entitled “Silent Waves, Theory and Practice of Lymph Drainage Therapy” by Bruno Chickly, M.D., D.O. (hon) and published by International Health & Healing Inc. Publishing of Scottsdale, Ariz., the lymph system is a secondary circulatory system that normally implements a one-way flow of the excess protein, fat and other waste bearing material (i.e., as lymph fluid) generally upwards from the interstitial space 50 through various lymph flow channels toward the right lymphatic and thoracic ducts (not shown). These ducts then drain the lymph fluid into the circulatory system at the right and left subclavian veins (also not shown), and then pass the assimilated lymph fluid sequentially through the right side of the heart 26, the lungs 32a/b, the left side of the heart 26, and finally, to the liver 88 and/or kidneys 90a and 90b for processing and proper disposition.

As depicted schematically in FIG. 5, one-way flows of lymph fluids within the lymph system generally pass through a multitude of lymph collectors 70 each comprising closely spaced sequential one-way valves 72 (i.e., similar but much smaller than those found in veins 64) interconnected by very short segments of lymphatic vessels 74 called lymphangions (hereinafter “lymphangions 74”). The lymphangions 74 are only about 6 to 20 mm long (i.e., as described in “The Genetic History of the Valves in the Lymphatic System of Man”, by O. F. Kampmeir, Am. J. Anat. 1928, 40:413-457). They comprise spiral muscle layers 76 that contract involuntarily in response to innervation signals issuing from the person's autonomic nervous system as indicated schematically at numeric indicator 78.

When a person is at rest, the rate of such lymphangion contractions normally occurs at about 5 to 8 cycles/minute (i.e., as described in “Intrinsic Contractility of Leg Lymphatics in Man: Preliminary Communication”, by W. L. Olszewski et. al., Lymphol, 1979, 12: 81-84: and “Intrinsic Contractility of Prenodal Lymph Vessels and Lymph Flow in Human Leg” by W. L. Olszewski et. al., Am. J. Physiol, 1980, 239:775-783). In so doing, the combinations of sequential one-way valves 72, lymphangions 74, and spiral muscle layers 76 act as pumping mechanisms that serve to force the lymph fluid through the one-way valves 72 and on to the right lymphatic and thoracic ducts—thus moving the one-way flow of excess protein, fat and other waste bearing lymph fluid generally upwards through the person's lymphatic flow channels and eventually on to the right and left subclavian veins as described above.

As depicted schematically in FIGS. 6A and 6B, excess interstitial fluid first becomes lymph fluid by entering minute lymph capillaries (not shown) formed like cul-de-sacs and located in extra cellular spaces surrounding each one of an enormous multitude of lymph pre-collectors 80. As shown in FIG. 5A, the lymph fluid next enters the lymph pre-collectors 80 through open junction ends 82 whenever the fluid pressure in the lymph pre-collectors 80 is less than that present in the minute lymph capillaries, and of course, juxtaposed interstitial space 50. Anchoring filaments 84 help to open the junction ends 82 widely whenever that differential fluid pressure becomes significant. The lymph fluid next enters juxtaposed lymphangions 74 via lymphatic bicuspid valves 86.

On the other hand, whenever the fluid pressure in the lymph pre-collectors 80 is more than that present in the minute lymph capillaries, the junction ends 82 immediately close as shown in FIG. 6B in order to prevent back flow of lymph fluid into the minute lymph capillaries. Similarly, the lymphatic bicuspid valves 86 are closed by inverse differential fluid pressure whenever higher pressure is present in the juxtaposed lymphangions 74 in order to preclude lymph fluid back flow into the lymph pre-collectors 80.

Should any of the veins 64 be subject to continuous increased pressure values (i.e., such those in one's feet while on a long airplane trip) the normal osmotic flow of interstitial fluid back into juxtaposed capillaries 46 via the micro-pores 58 will be somewhat impeded and the interstitial space pressure will increase in accordance with the above described net inward driving pressure of about 5 mmHg into the venule ends 60 of the capillaries 46. In addition however, there will be a concomitant increase of lymph system backpressure (i.e., also due to gravity effects). Thus, the normal upward one-way flow of lymph fluid will also be impeded and tend to back up. All of this results in a significant increase in the volume of fluid trapped in the interstitial space 50. These phenomena coupled with some swelling of juxtaposed arteries 42 and veins 64 are responsible for the feet swelling during prolonged airplane trips.

Generally, lymph fluid movement occurs slowly and sometimes problematically at volumetric rates of up to only about 4 liters/day with nominal differential driving pressures of only 1 to 2 mmHg above surrounding interstitial space 50 provided by the smooth spirally oriented spiral muscle layer 76 of each lymphangion 74. Blockages can occur—often as a result of trauma or surgery. Such blockages can cause abnormally high intralymphatic pressures and excessively dilated lymphangions 74, which in turn result in juxtaposed ones of the one-way valves 72 becoming incompetent. This of course halts normal lymph flow and even allows lymph fluid to flow backwards. In turn, “upstream” lymphangions 74 then excessively dilate with more one-way valves 72 becoming incompetent. This incompetency is then transmitted back to the lymphatic bicuspid valves 86 and finally to the junction ends 82, with lymph fluid then being unable to flow in from the interstitial space 50. The result is an accumulation of lymph fluid in the interstitial space 50 and thus, lymphedema with abnormal tissue swelling.

Experimentally, it has been observed that a person 12's normal lymphangion contraction rate of 5 to 8 cycles/minute will morph into a matching nominal 6 cycles/minute when that person is using a recliner bed or chair 10/11 operating in its 6 cycles/minute mode. In fact, his or her lymphangion contraction rate becomes synchronous with the recliner bed or chair 10/11's motion in a phase-locked manner. Generally in this case, the lymphangion spiral muscles fire during the period when the force of gravity aids the forward flow of lymph. This tends to evacuate the “upstream” portions of lymph system whereby they are ready to accept an increased charge of new lymph fluid a half cycle later, What is really amazing is that it has also been found that when the recliner bed or chair 10/11 is operating in its 3-cycles/minute mode, the person 12's normal lymphangion contraction rate of 5 to 8 cycles/minute still morphs into a nominal 6 cycles/minute operational frequency wherein his or her lymphangion contraction rate again becomes synchronous with the recliner bed or chair 10/11's motion—but in this case, in a phase-locked manner every other cycle. This allows all of the person's lymphangion spiral muscles to fire (i.e., concomitantly in both of the lower extremities 18 and the upper torso 14 and head 16) during periods when the force of gravity will thus alternately aid the forward flow of lymph in the lower extremities 18, and also in the upper torso 14 and head 16.

With either of the 3 or 6 cycles/minute operational frequencies, it has been found that when either the upper torso 14 and head 16, or the lower extremities 18 are elevated, a significantly larger volume of forward flow of lymph fluid occurs through comprised lymphangions 74 because the force of gravity then assists the lymphangion spiral muscle layer contraction in driving the lymph fluid forward. It is further hypothesized that this results in significantly lowered pressure values in “upstream” lymphangions 74, and juxtaposed lymph pre-collectors 80 and lymph capillaries. Then a half cycle later when the upper torso 14 and head 16, or the lower extremities 18 are lowered and their interstitial spaces 50 are subject to a slightly increased volume and positive pressure, entry of interstitial fluid into the lymph capillaries, lymph pre-collectors 80 and juxtaposed lymphangions 74 is enhanced and thereby increases incoming lymph flow volume.

In fact, such improvement in lymph system function has been anecdotally observed in case studies wherein a relatively rapid reversal of lymphedema with abnormal tissue swelling has occurred in conjunction with utilizing a recliner bed or chair 10/11. This is believed to have occurred in part as a result of the above-described cyclic tissue compression and relaxation clearing problematic lymphatic flow channel blockages—and also in part as a result of an increased flow of lymph fluid implemented by the lymphangion spiral muscle rate locking on to the approximately 6 cycles/minute cyclic operational frequency in the also above-described phase locked manner. Thus, it is believed herein that lymph circulation is significantly enhanced via utilization of the BPM therapy method 100.

The cyclic motion of a recliner bed or chair 10/11 also modulates the venous blood pressure present at the entrance to the heart 26 between positive and negative values—perhaps with an average offset toward the positive values. This results in a modulation of venous return to the heart 26 that in turn leads to a modulation of cardiac output because the charge volume of venous blood entering the heart 26 is largely a function of the cyclically varying venous blood pressure at the entrance to the heart 26. Thus blood flow and pressure tend to increase during periods when the head and torso are lowered and decrease when the head and torso are elevated. It is thought by some that this modulation of cardiac output might result an increase in arterial generation of the vasodilator NO₂ commonly called nitric oxide (but perhaps more correctly referred to as nitrogen dioxide). It is thought that this could lead to a general dilation of the arterial system and perhaps an improved delivery of blood and nutrients throughout the body. Specifically, along with the other benefits described above, it is thought that this might be a factor in the anecdotally observed reversal of neuropathy and/or open wound healing.

Additionally, it is also believed herein that the above-described working of tissue constitutes an internally generated form of exercise that consumes and converts chemical energy derived from nutrients present in the blood into heat on a micro level thereby increasing metabolism. A person can readily demonstrate this concept as follows:

While leaving one hand immobile, that person cyclically elevates and then lowers the other at a rate of about 6 cycles/minute for a couple of minutes. If the palms of both hands are than put on the cheeks he or she will find that the one that was elevated and lowered is considerably warmer than the one that was left immobile—even though it had been gorged with venous blood. Further, he or she will likely experience a significant tingling sensation in the elevated and lowered hand.

It has been anecdotally found that blood glucose levels are generally reduced in persons utilizing the BPM therapy method 100. It is believed herein that the above listed hypothesized mechanisms are responsible for this phenomenon. The enhancement of lymph circulation is of specific interest in this regard because it is hypothesized that it assists in disposing of incompletely metabolized sugar stored in the interstitial spaces 50. In any case, the reduction of blood glucose levels is quite beneficial for persons having diabetes, and has typically occurred in persons having either Type 2 diabetes or Type 2 diabetes with insulin. On the other hand, it can lead to a non-diabetic person achieving too low a sugar level. It has been found that if one is subject to this type of condition, he or she can usually avoid it by consuming a glass of fruit juice before and even after utilizing the BPM therapy method 100.

Approximately 86,000 diabetic persons now suffer lower extremity amputations every year as a result of having supposedly irreversible neuropathy, extreme peripheral artery disease or incurable wounds (i.e., that turn gangrenous) as well as the above noted lower limb lymphedema with abnormal tissue swelling. In addition to reversing the lymphedema with abnormal tissue swelling in the manner described hereinabove, the BPM therapy method 100 has also been anecdotally found to reverse such supposedly irreversible neuropathy and extreme peripheral artery disease as well as achieve therapeutic closure of such supposedly incurable wounds. It is believed herein that the above listed hypothesized mechanisms are responsible for this phenomenon. Specifically, it is hypothesized that these results are at least in part a result of increased blood flow and are yet other manifestations of the above-described manner in which the BPM therapy method 100 typically clears blockages in fluid flow channels.

It is not believed that BPM therapy has the capability of “regenerating” nerves. None-the-less, other case studies have served to anecdotally demonstrate reduction of nerve related disorders such as indicated by significantly reduced symptoms of persons having “early onset” Parkinson's disease. In accordance with the latest theories relating to the cause of Parkinson's disease such as by toxic “clumping” destruction of substantia nigra (SN) neurons (i.e., as shown in “Aggregation of alpha-synuclein by DOPAL, the monoamine osidase metabolite of dopamine”, by William J. Burke et. al. and published on line in Acta Neuropathologica, copyright Springer-Verlag 2007), it is believed herein that the above described manipulation of related neural flow channels tends to break down the “clumping” action and thereby restore still surviving SN neurons to proper functionality.

A reduction of medication dosages, or in some cases even their total elimination, has been a further benefit for many persons utilizing BPM therapy. By way of example, some persons having Type 2 diabetes with insulin have had to reduce or even eliminate their usage of insulin in order to avoid becoming hypoglycemic because of the above noted reduction of blood glucose. In another example, persons having Parkinson's disease have typically had to reduce their normally prescribed medication dosages in order to avoid overdose symptoms (i.e., such as uncontrolled and wildly gyrating arm and leg motions). It is hypothesized that many such reductions of medication dosages have come about because of increased blood circulation and/or elimination of the above described “clumping” action resulting from using BPM therapy. Therefore, an additional benefit of using BPM therapy may be that medication dosages can be reduced, or in some cases even eliminated.

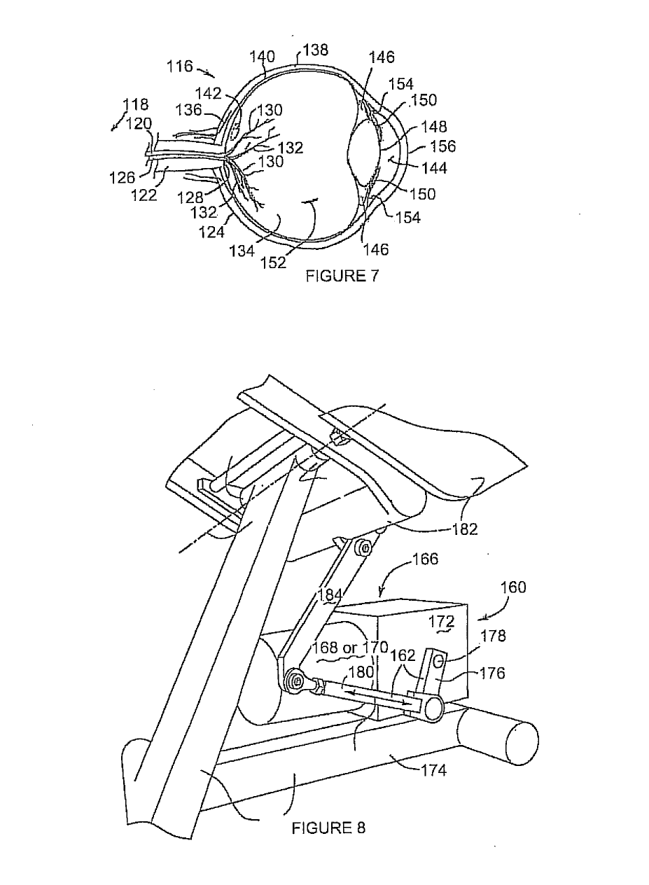

As described in detail in the incorporated '901 patent application, the “wet” aspects of wet macular edema, wet macular degeneration and wet diabetic retinopathy as well as high intraocular pressure commonly associated with glaucoma can be reversed via utilization of the BPM therapy method 100. Because a complete description of a human eye is presented in the incorporated '901 patent application, it will not be repeated herein. None-the-less, because the eye differs significantly from those bodily elements so far discussed, a synopsis of its makeup and these amazing results is hereinbelow presented in conjunction herein with reference to FIG. 7 wherein numerical indicators designating the various elements of an eye 116 are designated as follows: ophthalmic artery 118; central retinal artery 120; optic nerve 122; globe 124; central retinal vein 126; optic nerve head 128; main arterial vessels 130; main venous vessels 132; retina 134; posterior ciliary arteries 136; sclera 138; choroidal tissue elements 140; macula 142; aqueous humour 144; ciliary body 146; lens 148; iris 150; vitreous humour 152; filtration angle 154; and cornea 156.

The eye 116 is normally one of the best-perfused organs in the body. Blood is primarily supplied to the eye 116 from the ophthalmic artery 118. A central retinal artery 120 branches off the ophthalmic artery 118 to penetrate the optic nerve 122 about 10 to 15 mm behind the globe 124. The central retinal artery 120 courses adjacent to a central retinal vein 126 within the central portion of the optic nerve 122. The central retinal artery 120 and central retinal vein 126 emerge from the center of the optic nerve head 128 and branch into four sets of nominally juxtaposed main arterial and venous vessels 130 and 132. The main arterial vessels 130 supply blood to the inner portion of the optic nerve head 128 and the inner two-thirds of the retina 134 in the following manner:

The main arterial vessels 130 divide into finer and finer arterial vessels that convey arterial blood through very fine capillaries from which blood plasma separates and conveys oxygen and nutrients to the retinal tissue cells. The plasma retrieves carbon dioxide and other waste materials from the retinal tissue cells and then renters the capillaries whereby the blood therein becomes venous blood that in turn is collected by fine branches of the main venous vessels 132 and returned to the venous system via the central retinal vein 126. Although retinal blood flow accounts for only about 15% of total ocular blood circulation, it is critical because it nourishes highly metabolically active retinal tissue and especially that in the macula 142.

The remainder of the eye 116 is supplied with blood via posterior ciliary arteries 136 that also branch from the ophthalmic artery 118 but in this case do not penetrate the optic nerve 122. Instead, they independently attach to the globe 124 and pierce the sclera 138 to nourish choroidal tissue 140 located behind the retina as well as the anterior one-third portion of the retina 134.

Yet another element of eye profusion relates to a continuous flow of intraocular fluid known as aqueous humour 144 through the eye 116. The aqueous humour fluid is produced by the ciliary body 146 from blood provided to it from the ophthalmic artery 118 via the choroidal blood flow system. It flows through the anterior portions of the eye 116 to and then through the filtration angle 154 into venous vessels comprised within the sclera 138, and then on through the main venous vessels 132 to the venous system 28a/28b. Thus, both the source and ultimate destination of the aqueous humour fluid are tied to portions of the human circulatory system 20 located in the head 16.

As a result, it is believed herein that pressure values within the aqueous humour 144 modulate significantly in concert with motion of the recliner bed or chair 10/11. It is further believed that this modulation of aqueous humour pressure is imposed upon the vitreous humour 152 and thereby impressed upon the retina 134, main arterial vessels 130, venous vessels 132, choroidal tissue elements 140 and thus the choroidal circulatory system, and finally, against the sclera 138 itself. In addition, this modulation of aqueous humour pressure is also imposed upon the lens 148, iris 150, cornea 156 and filtration angle 154.

Thus, it is believed herein that all elements of the eyes 116 are subject to mechanical manipulation. It is believed that this mechanical manipulation may enable a general cleansing of the various arterial and venous vessels, thus improving vascular tone of the various fine arteries, capillaries and veins comprised within the retinal and choroidal blood flow systems. It is also believed that the function of lymph system components comprised in the eyes 116 is enhanced.

In particular now with reference to the “wet” aspects of wet macular edema, wet macular degeneration and wet diabetic retinopathy, it is reasonable to assume that localized interstitial fluid pressure behind the macula 142 must be elevated significantly above intraocular pressure in order to support fluid leakage into the macular region of the eye 116. Further then, localized venous and lymph pressures must also be similarly elevated in order to support the localized elevated interstitial fluid pressure behind the macula 142, whereby it must be concluded that blockages must be present in both localized venous and lymph flow channels. Thus, it is hypothesized herein that the operative mechanisms behind the observed reversal of the “wet” aspects of wet macular edema, wet macular degeneration and wet diabetic retinopathy via utilization of the BPM therapy method 100 are as follows:

It is believed herein that the above described general cleansing of the various arterial and venous vessels is active here in clearing the blockages present in the localized venous and lymph flow channels. Then the localized interstitial fluid pressure is able to drop significantly in concert with localized venous pressure assuming normal lower values. It is hypothesized that the localized interstitial fluid pressure in fact drops to a value significantly lower than aqueous humour pressure whereby pressure exerted by the aqueous humour 144 on the vitreous humour 152 (or around the vitreous humour 152 if it has separated from the retina 134) is able to drive the previously leaked blood back into the localized interstitial space. It is further hypothesized that the previously leaked blood is accepted by localized lymph pre-collectors 80 and collectors 70 (none shown in FIG. 7) and conveyed via the lymphatic system downward to the right lymphatic duct and on to the right subclavian vein and heart in the manners described above. This method of disposal is deemed necessary because of the presence of large molecules that are logically unable to reenter micro-pores 58 of localized venule ends 60 of localized capillaries 46 (none shown in FIG. 7).

After macular degeneration, glaucoma is the second leading cause of blindness. In general, it is caused by a gradual loss of blood profusion to the retina 134, particularly in those anterior portions of the retina 134 supplied by the choroidal blood flow system. The principle factor that determines local blood flow to the retina 134, and particularly to those anterior portions of the retina 134 supplied by the choroidal blood flow system, is perfusion pressure vs. intraocular or aqueous humour pressure. Thus, high aqueous humour pressure, or more simply “high eye pressure”, (i.e., higher than 21 mmHg) is widely thought to be the principle cause of glaucoma. Generally it is said to relate to problematic drainage of aqueous humour fluid through the filtration angle 154. It is believed herein however, that the above-described general cleansing, as enabled by the BPM therapy method 100, extends to breaking down and removing any contaminants partially blocking the filtration angle 154 whereby that is the mechanism behind a generally observed reversal of high eye pressure values.

A drive mechanism is utilized for rotatably moving the recliner bed or chair 10/11 in a cyclical manner between the extreme positions depicted in FIG. 1A or 2A, and 1C or 2C at either of the 3 or 6 cycles/minute frequencies. The incorporated '033 patent depicts a Scotch yoke drive assembly 96, a crank and connecting rod mechanism 188, a servo controlled rack and pinion gear set 194, and a servo controlled hydraulic drive 196, any of which would be suitable for cyclically moving the sub recliner bed or chair 10/11 of the present invention. Because descriptive presentations of the Scotch yoke drive assembly 96, the servo controlled rack and pinion gear set 194, and the servo controlled hydraulic drive 196 have been made in the incorporated '033 patent, no further description relating to any of these types of drive mechanisms is required herein. On the other hand as shown herein in FIG. 8, the preferred recliner bed and chair 10/11 of the present invention utilizes a simplified example drive mechanism 160 that comprises a crank and connecting rod mechanism 162.

FIG. 8 is a perspective view of the drive mechanism 160 with a crank and connecting rod cover 164 shown in FIGS. 1A, 1B, 1C, 2A, 2B and 2C removed. In this example, the drive mechanism 160 includes the crank and connecting rod mechanism 162, and a gearmotor 166 comprising either a two-speed drive motor 168 or a three-phase drive motor 170 and a speed-reducing gearbox 172 mounted upon a machine base 174. The crank and connecting rod drive mechanism 162 includes a crank 176 that is driven via an output shaft 178 of the speed-reducing gearbox 172. The crank 176 engages a connecting rod 180 that is pivotally connected to a bed or chair member 182 of the recliner bed or chair 10/11 via a lever 184. A simple center-off three-position switch 186 (shown in FIGS. 1A, 1B, 1C, 2A, 2B and 2C) can be used to control the two-speed drive motor 168 in the event that it is selected to drive the gearmotor 166.

On the other hand, a purpose-designed and built control apparatus 190 should be utilized to control the three-phase drive motor 170. This is necessary because commercially available inverters typically utilize a pulse width modulated bridge circuit comprising solid state switching devices that are usually relatively unshielded and are therefore a source of high frequency electromagnetic radiation. This is considered to be undesirable by a significant percentage of potential users of a recliner bed or chair 10/11. In fact, such high frequency electromagnetic radiation could conceivably be dangerous for individuals using pacemakers.

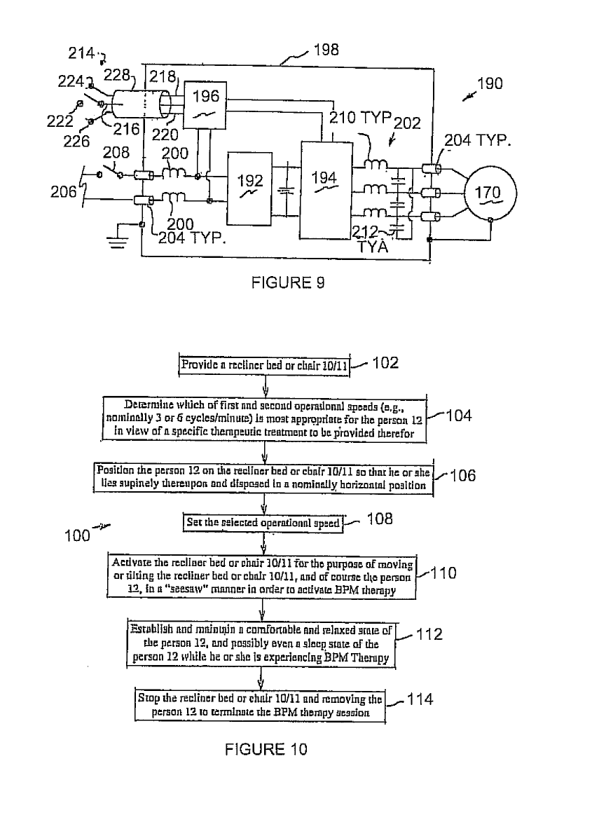

FIG. 9 is a schematic drawing of an example purpose-designed and built control apparatus 190 that could be utilized for driving the three-phase drive motor 170 at either of first and second output speeds that respectively result in the output shaft 178 of the speed-reducing gearbox 172 rotating at the 3 and 6 cycles/minute rates. The example purpose-designed and built control apparatus 190 includes a rectifier 192 that supplies DC power to a three-phase inverter 194 whose operation is controlled by a controller 196. All are mounted in an EMI shielded box 198 with input power conveyed through input lines buffered by inductors 200; outgoing power lines isolated by a three-phase low pass filter 202; and both routed through grounded feed through fittings 204.

In greater detail, the input power is provided to the purpose-designed and built control apparatus 190 from a single-phase power source 206 via a switch 208. It then enters the EMI shielded box 198 via the grounded feed through fittings 204 and the inductors 200 and is then conveyed to the rectifier 192 wherein it is rectified and sent on to the three-phase inverter 194.

Output power is provided to the three-phase drive motor 170 by the three-phase inverter 194 as controlled by the controller 196 in accordance with a selected volt/Hz value. The output power is conveyed to the three-phase drive motor 170 via the three-phase low pass filter 202. The three-phase low pass filter 202 is configured as a three-phase two-pole low pass filter 202 comprising three inductors 210 and three capacitors 212. In this case, the three inductors 210 and three capacitors 212 are preferably sized such that they form a load matched three-phase two-pole low pass Butterworth filter 202. Given these descriptions, one of ordinary skill in the electronic and electrical power apparatus arts will recognize and be able to generate suitable designs for the preferred load matched three-phase two-pole low pass Butterworth filter 202.

Operation of the controller 196 is achieved via manipulation of a three-position switch 214. Power is supplied from the controller 196 to the three-position switch 214 by a low voltage line 216 and returned via either of first and second control lines 218 and 220 as selectively determined by re-positioning the three-position switch 214 from a center off position 222 to respective first or second contacts 224 or 226. The low voltage line 216 and first and second control lines 218 and 220 are conveyed to the three-position switch 214 within a grounded sheath 228. And of course, all physical elements of the purpose-designed and built control apparatus 190 as well as structures comprised in the recliner bed and chair 10/11 are grounded as well.

FIG. 10 illustrates an example method 100 of providing BPM therapy for therapeutically treating each person 12's health issue as deemed most appropriate for that person 12 on a recliner bed or chair 10/11. A first step 102 of the example BPM therapy method 100 includes providing a recliner bed or chair 10/11. A second step 104 includes determining which of first and second operational speeds (e.g., nominally 3 or 6 cycles/minute) is most appropriate for the person 12 in view of a specific therapeutic treatment to be provided therefor. A third step 106 includes positioning the person 12 on the recliner bed or chair 10/11 so that he or she lies supinely thereupon and disposed in a nominally horizontal position. A fourth step 108 includes setting the selected operational speed. A fifth step 110 includes activating the recliner bed or chair 10/11 for the purpose of moving or tilting the recliner bed or chair 10/11, and of course the person 12, in a “seesaw” manner in order to activate BPM therapy. A sixth step 112 includes establishing and maintaining a comfortable and relaxed state of the person 12, and possibly even a sleep state of the person 12 while he or she is experiencing BPM Therapy. And finally, a seventh step 114 includes stopping the recliner bed or chair 10/11 and removing the person 12 to terminate the BPM therapy session.

Although preferred embodiments of this invention have been disclosed, workers of ordinary skill in the various arts associated with this invention would recognize that certain modifications would come within the scope of this invention. For instance, BPM therapy could be utilized for treating diseases or conditions not named above. Also, the construction details of a recliner bed or chair 10/11 or of the purpose-designed and built control apparatus 190 could be altered without deviating from the spirit of this invention. By way of example, the speed-reducing gearbox 172 could be replaced by the combination of a hydraulic pump and hydraulic motor whose output shaft would then be utilized for driving the crank 176. Also, another type of polyphase drive motor could be used in place of the three-phase drive motor 170. For that reason, the following claims should be studied to determine the true scope and content of this invention.

What is claimed is:

1. A method for therapeutic treatment of a disease or ailment condition through the use of venous blood pressure modulation (BPM) therapy conducted either at a cyclic rate falling somewhere within the frequency range of a human lymph system's normal lymphangion contraction rate divided by 2, or alternately, at a cyclic rate falling somewhere within the frequency range of a human lymph system's normal lymphangion contraction rate, said method comprising the steps of:
providing a recliner bed or chair BPM apparatus comprising:
a reclining bed or chair member configured to selectively retain a person thereupon in a supine manner generally along a longitudinal axis such that said person's upper torso and head are longitudinally spaced apart from said person's lower extremities;
said recliner bed or chair BPM apparatus further including apparatus for pivotingly supporting said reclining bed or chair member about a transversely disposed pivot axis nominally orthogonal to a vertical plane comprising said longitudinal axis, said longitudinal axis of said reclining bed or chair member then being operative for defining instant rotational orientations of said reclining bed or chair member around said pivot axis;
said recliner bed or chair BPM apparatus further including a motor; and
a drive mechanism for selectively coupling said motor to said reclining bed or chair member;
wherein said motor is energizable at either of selected first and second operational speeds for respectively rotatably and cyclically moving said reclining bed or chair member about said pivot axis either at a cyclic rate falling somewhere within the frequency range of a human lymph system's normal lymphangion contraction rate divided by 2, or alternately, at a cyclic rate falling somewhere within the frequency range of a human lymph system's normal lymphangion contraction rate;
determining which of the first and second operational speeds is most appropriate for said person in view of a specific therapeutic treatment to be provided therefor;
disposing a person on said reclining bed or chair member so that said person lies supinely thereupon with his or her upper torso and head, and lower extremities spaced apart generally along said longitudinal axis;
setting said selected operational speed; and
energizing said motor so as to activate said recliner chair BPM apparatus and thereby rotatably move said reclining bed or chair member about said pivot axis through many cycles wherein said person's lower extremities are raised to a level higher than said person's upper torso and head, and vice-versa during each cycle;
wherein each cycle causes a modulation of the person's venous blood pressure wherein resulting multiple venous blood pressure modulation and/or switching events cause cyclic swelling and shrinking of the veins of the person's upper torso and head, and concomitantly, shrinking and swelling of the veins of the person's lower extremities;
wherein said cyclic swelling and shrinking of the veins of the person's upper torso and head, and concomitantly, shrinking and swelling of the veins of the person's lower extremities result in cyclic swelling and shrinking of the tissues of the person's upper torso and head, and concomitantly, shrinking and swelling of the tissues of the person's lower extremities;
wherein said cyclic swelling and shrinking of the tissues of the person's upper torso and head, and concomitantly, shrinking and swelling of the tissues of the person's lower extremities result in cumulative internal massaging of arteries and fine arteries, neural fluid flow channels, and lymph fluid flow channels in the person's upper torso and head, and/or lower extremities; and
further wherein said cumulative internal massaging of arteries and fine arteries, neural fluid flow channels, and lymph fluid flow channels in the person's upper torso and head, and/or lower extremities results in clearing said arteries and fine arteries, neural fluid flow channels, and lymph fluid flow channels of accumulated obstructions to a normal flow of fluids therein.

2. The method as set forth in claim 1, wherein the angular range of motion of said longitudinal axis of said reclining bed or chair member, and said person, is about 30 degrees.

3. The method as set forth in claim 2, wherein the angular range of motion of about 30 degrees extends symmetrically to either side of a nominally centered position.

4. The method as set forth in claim 1, wherein the first and second operational speeds of said motor result in the reclining bed or chair member moving at respective cyclical rates of about 3 and 6 cycles/minute.

5. The method as set forth in claim 1, wherein said motor is a two-speed motor.

6. The method as set forth in claim 1, wherein said motor is a three-phase motor.

7. The method as set forth in claim 6, wherein said motor is driven by a purpose-designed and built control apparatus comprising a three-phase inverter.

8. The method as set forth in claim 7, wherein said purpose-designed and built control apparatus additionally comprises an inductive buffer for isolating incoming power lines from EMI issuing from said three-phase inverter.

9. The method as set forth in claim 8, wherein said inductive buffer comprises first and second inductors respectively placed in the “hot” and common incoming power lines.

10. The method as set forth in claim 7, wherein said purpose-designed and built control apparatus additionally comprises a three-phase low pass filter for isolating outgoing power lines from EMI issuing from said three-phase inverter.

11. The method as set forth in claim 10, wherein said three-phase low pass filter is a load matched three-phase two-pole low pass Butterworth filter

12. The method as set forth in claim 1, wherein said drive mechanism is selected from the group comprising a Scotch yoke mechanism, a crank and connecting rod mechanism, a linear drive mechanism, and a hydraulic drive mechanism.

13. The method as set forth in claim 1, wherein said drive mechanism is a crank and connecting rod mechanism.

14. The method as set forth in claim 1, wherein the disease or ailment condition is from among the group comprising peripheral artery disease, Parkinson's disease, Alzheimer's disease, essential tremor, muscular dystrophy, autism, migraine headaches, traumatic brain injuries, varicose veins, fibromyalgia, eye problems such as wet macular edema, wet macular degeneration and glaucoma, and diabetes related problems such as high glucose count, impaired circulation, neuropathy, open wounds, and lymphedema with abnormal tissue swelling.

15. The method as set forth in claim 1, wherein the disease or ailment condition is peripheral artery disease.

16. The method as set forth in claim 1, wherein the disease or ailment condition is Parkinson's disease.

17. The method as set forth in claim 1, wherein the disease or ailment condition is Alzheimer's disease.

18. The method as set forth in claim 1, wherein the disease or ailment condition is essential tremor.

19. The method as set forth in claim 1, wherein the disease or ailment condition is muscular dystrophy.

20. The method as set forth in claim 1, wherein the disease or ailment condition is autism.

21. The method as set forth in claim 1, wherein the disease or ailment condition is migraine headaches.

22. The method as set forth in claim 1, wherein the disease or ailment condition is traumatic brain injuries.

23. The method as set forth in claim 1, wherein the disease or ailment condition is varicose veins.

24. The method as set forth in claim 1, wherein the disease or ailment condition is fibromyalgia.

25. The method as set forth in claim 1, wherein the disease or ailment condition is from among an eye related group comprising wet macular edema, wet macular degeneration and glaucoma.

26. The method as set forth in claim 1, wherein the disease or ailment condition is wet macular edema.

27. The method as set forth in claim 1, wherein the disease or ailment condition is wet macular degeneration.

28. The method as set forth in claim 1, wherein the disease or ailment condition is glaucoma.

29. The method as set forth in claim 1, wherein the disease or ailment condition is from among a diabetes related group comprising high glucose count, impaired circulation, neuropathy, open wounds, and lymphedema with abnormal tissue swelling.

30. The method as set forth in claim 1, wherein the disease or ailment condition is high glucose count.

31. The method as set forth in claim 1, wherein the disease or ailment condition is impaired circulation.

32. The method as set forth in claim 1, wherein the disease or ailment condition is neuropathy.

33. The method as set forth in claim 1, wherein the disease or ailment condition is open wounds.

34. The method as set forth in claim 1, wherein the disease or ailment condition is lymphedema with abnormal tissue swelling.

35. The method as set forth in claim 1, wherein the method additionally comprises the steps of:
locating said recliner BPM apparatus in a relatively isolated and quite environment; and
maintaining a comfortable and relaxed state of the person.

36. The method as set forth in claim 35, wherein maintaining the comfortable and relaxed state of the person comprises avoiding any contact with the person (i.e., such as talking to him or her) with the purpose of inducing him or her into a state of sleeping.
